(19) United States
(12) Patent Application Publication
(10) Pub. No.: US 2002/0158796 A1
(43) Pub. Date: Oct. 31, 2002

(54) Integrated GPS and IGS system and method

(76) Inventors: Ian Humphrey, Foxboro, MA (US); Michael S. Perlmutter, Sherborn, MA (US)

Correspondence Address: FOLEY HOAG LLP, PATENT GROUP, WORLD TRADE CENTER WEST, 155 SEAPORT BOULEVARD, BOSTON, MA, 02110-2600, US

(21) Appl. No.: 09/967,411

(22) Filed: Sep. 28, 2001

Related U.S. Application Data
(60) Provisional application No. 60/286,691, filed on Apr. 25, 2001.

(51) Int. Cl. G01S 5/14; G01C 21/26

(52) U.S. Cl. 342/357.14; 701/216

(57) ABSTRACT

A method and system for integrating a IGS system and a GPS receiver. A predictive filter can measure signal quality from the GPS receiver and accordingly provide parameter estimates by appropriately weighting signal data from the GPS receiver and the IGS system. When GPS signal quality is high, the GPS signal data can be provided proportionately greater weight than the IGS system data, and the IGS/GPS integrated filter outputs can provide compensation to the IGS system for bias errors, etc. Alternately, if the GPS signal data is degraded or unavailable, the IGS signal data can be provided proportionately greater weight than the GPS signal data to provide higher quality inputs to the GPS receiver trackers than would otherwise be available.

### CLAIM OF PRIORITY

This application claims priority to U.S. Ser. No. 60/286,691, entitled “Systems And Methods For An Integrated Global Positioning And Inertial Guidance Navigational System Having A Single Processor”, and filed on Apr. 25, 2001, naming Michael Perlmutter and Ian Humphrey as inventors, the contents of which are herein incorporated by reference in their entirety.

### BACKGROUND

(1) Field

The disclosed methods and systems relate generally to navigational systems, and more particularly to integrated global positioning and inertial navigational systems.

(2) Description of Relevant Art

Global Positioning Systems (GPS) are almost ubiquitous in modern society aiding individuals to navigate with a high degree of accuracy based on a relative position of numerous satellites. A GPS system, however, depends on the line-of-sight availability of a GPS satellite signal. There are instances in which potentially available GPS satellite signals can be made unavailable by physical (e.g., tall buildings) and other (e.g., electromagnetic) obstructions. In these cases, navigational systems often rely on other positioning information, or simply accept the inaccuracies from a failure to obtain the signal. Integrated navigational systems (INS) that incorporate GPS with inertial guidance systems (IGS) can provide more accurate navigational information and can be used in many different applications, including for example, new commercial and private vehicles. In these systems, data from both systems can be combined and provided to a display or other system.

Currently, the navigational systems proposed for use in vehicles can be implemented with digital signal processors (DSPs) that are separate from the processors used for the vehicle's other processor-controlled functions. Further, the GPS DSP can be separate from the DSP for the IGS in an integrated navigational system. This use of multiple processors can require additional hardware, leading to higher cost and more points of (hardware) failure. Additionally, there is undue multiplicity of processing capability and inefficient utilization of physical space. For example, in a vehicle application, a vehicle dashboard console can prevent inclusion of other devices in the limited space.

Currently, to have continuous navigational capacity, vehicle manufacturers often provide space for external hardware for GPS and IGS equipment and internal space for processors, supplies, electronic component boards, boxes, and other hardware for different systems in the integrated navigational system. This can result in significant extra hardware and space restrictions, and limited functionality. Furthermore, multiple processors introduce errors due to the asynchronous processing amongst the various processors. Additionally, although the GPS and IGS data are combined, the combined data values can be considered to be vulnerable to a bad measurement from either of the systems, as the individual systems do not benefit from each other, and merely provide an output to be combined.

### SUMMARY

The disclosed methods and systems can integrate a global positioning system receiver (GPS) and an inertial guidance system (IGS) to provide feedback between the components of the GPS and IGS systems. The method and system can include providing a first estimate for at least one parameter from the GPS, providing a second estimate for the at least one parameter from the IGS, taking a difference between the two estimates, and providing a combined estimate of the at least one parameter based on the difference data. The combined estimate can be used to compensate the IGS and GPS.

In one embodiment a filter can be used to provide the combined estimate, and the filter can weight the first estimate and the second estimate. The first and second estimates can be weighted using a covariance matrix, for example. In one embodiment, the difference between the two estimates can be weighted.

The parameters to be estimated can include position, velocity, attitude, acceleration, angular rate, scalefactors (gyroscope, odometer), accelerometer bias, gyroscope bias, GPS clock bias, and GPS clock drift bias. The compensation to the IGS and GPS systems can include an estimated range, range-rate, position, velocity, attitude, acceleration, accelerometer bias, gyroscope bias, gyroscope scalefactor, odometer scalefactor, angular rate, GPS clock bias, and a GPS clock bias drift. For example, the carrier phase tracking loop and code tracking loops of a GPS receiver can be compensated or updated using the combined position, velocity, range-rate, range, GPS clock bias, and GPS clock drift bias estimates. Alternately, the IGS can be compensated using position, velocity, attitude, acceleration, angular rate, accelerometer bias, gyroscope and odometer scalefactor, and gyroscope bias data or estimates from the filter.

In one embodiment, the IGS can include at least one accelerometer, at least one gyroscope, and at least one odometer.

Other objects and advantages will become apparent hereinafter in view of the specification and drawings.

### BRIEF DESCRIPTION OF THE DRAWINGS

FIG. 1 is an integrated global positioning and inertial guidance system;

FIG. 2 provides an illustration of Kalman filter processing; and,

FIG. 3 is a prior art system.

### DESCRIPTION

To provide an overall understanding, certain illustrative embodiments will now be described; however, it will be understood by one of ordinary skill in the art that the systems and methods described herein can be adapted and modified to provide systems and methods for other suitable applications and that other additions and modifications can be made without departing from the scope of the systems and methods described herein.

Unless otherwise specified, the illustrated embodiments can be understood as providing exemplary features of varying detail of certain embodiments, and therefore features, components, modules, and or aspects of the illustrations can be otherwise combined, separated, interchanged, and/or rearranged without departing from the disclosed systems or methods.

The disclosed methods and systems include at least one processor that can include a digital signal processor, that can accept data from at least one GPS satellite and at least one inertial guidance sensor. The integrated system can utilize GPS signal data for long-term measurement and parameter estimate accuracy, while providing bias and other compensation factors to the inertial sensor data and/or measurements. Additionally, the integrated system can utilize the inertial measurement sensors during relatively short-term intervals during which the GPS signal may be degraded or unavailable, to allow the GPS trackers to maintain track throughout a loss or degradation of GPS signal, and to further allow an output system, display, application, etc., to continue to receive updated information although the GPS signal may be unavailable.

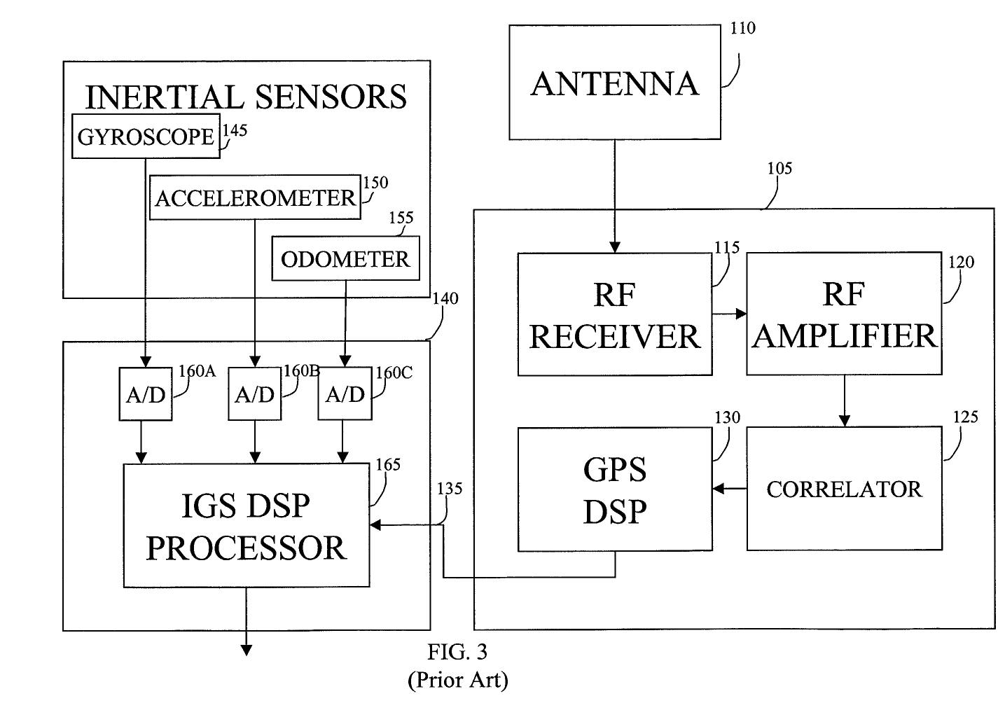

FIG. 3 illustrates a prior art Global Positioning System (GPS)/Intertial Guidance System (IGS) navigational system 100 having a first processor for GPS processing 130, and a distinct second processor for IGS processing 165. In the illustrated prior art system, the two processors 130, 165 reside on separate electronic components or boards that can be referred to as a GPS board 105 and an integration board 140. The GPS board 105 interfaces to an antenna 110 via a Radio Frequency (RF) receiver 115. The antenna 110 can receive at least one GPS signal and provide the signals to the RF receiver 115 that can filter or otherwise process the received antenna signals. The RF receiver outputs can be provided to an RF amplifier 120, and thereafter to a correlator 125. In the FIG. 3 system, the correlator 125 can demodulate the GPS signal and provide the baseband signal to the GPS DSP 130 for processing. One of ordinary skill in the art will recognize that the GPS DSP 130, as with the DSPs provided herein, can be any processor or microprocessor having instructions for causing the processor to perform according to the provisions herein. In the FIG. 3 system, the GPS DSP output can be GPS navigational data such as position and velocity that can be provided to the integration board 140 via a RS 232 or digital line 135.

The FIG. 3 integration board 140 can also interface to at least one accelerometer 145, at least one gyroscope 150, and at least one odometer 155, collectively referred to herein as inertial sensors, through at least one analog-to-digital converter (A/D) 160a-160c that can be located on the integration board 140. The A/D 160a-160c or other interface to the inertial sensors 145, 150, 155 can provide the IGS DSP 165 with the sensor data. For example, the accelerometer 145 can provide acceleration data, the gyroscope 150 can provide rate information, and odometer 155 can provide speed and distance information. The IGS DSP 165 can include processor instructions to combine the received GPS navigational data via a RS 232 or digital line 135, with the inertial sensor data, to provide navigational information or other data to a user. For the purposes of the disclosed methods and systems, a user can be an application, sensor, or system, including a display. In some embodiments, IGS DSP 165 can combine the inertial sensor data and GPS navigational data using filtering techniques including Kalman filters. IGS DSP 165 can also be any processor or processor-controlled device having executable instructions for causing the processor to perform as provided herein.

Although for the FIG. 3 system, the GPS and IGS measurements can be combined in the IGS DSP 165, the FIG. 3 prior art system does not provide feedback between the GPS and IGS systems. As is known in the art, GPS signal reception can be hampered by losses of transmission from the satellites due to obstruction of the signal, multipath effects, and interference or jamming of the system. Furthermore, inertial sensors can be known for long-term instability. By combining the sensor system measurements without providing feedback, the combined measurements can be vulnerable to the inaccuracies of the respective systems. The disclosed methods and systems provide an integrated GPS/IGS system to allow feedback between the IGS and GPS systems to increase the tracking accuracy and hence measurements from the GPS signal(s), increase the signal integrity and hence measurements from the IGS sensors, and provide an overall increased accuracy combined output that is less susceptible to degradations of performance of the individual systems.

As indicated herein, feedback between an IGS system and/or IGS sensors and a GPS system/receiver can be beneficial to both the IGS system, the GPS system, and any combined output from the systems. For example, an IGS system can be known to provide accurate measurements over a shorter time interval; however, IGS sensors can generally be considered less stable over a longer interval. Alternately, GPS signals can be considered reliable over long intervals, but may be less reliable over a shorter interval where, as mentioned previously herein, there can be multipath, interference, or other short term effects that can affect signal reception and/or quality. Such problems with signal quality and/or reception can affect tracking mechanisms or loops that are part of GPS receiver systems. Those with ordinary skill in the art know that a GPS signal is tracked by carrier and code, and a loss or degradation of GPS signal can adversely affect the respective GPS carrier and code trackers. Consequently, any measurements, estimates, etc., that use data from the receiver (i.e., trackers) can similarly be degraded. Accordingly, the disclosed methods and systems can utilize and integrate the GPS and IGS systems to compensate the IGS measurements using the GPS measurements to provide stability for the IGS measurements when the GPS signal is available; and, when the GPS signal can be degraded or unavailable for an interval, the disclosed methods and system can utilize the IGS measurements to compensate the GPS system, and in particular, the GPS code and carrier tracking systems. By providing the compensation to the GPS system, the respective trackers can be provided updated data even though a respective GPS signal (i.e., assuming an embodiment where multiple GPS signals are being tracked) may not be available. When the GPS signal becomes available, the trackers can re-acquire the signal without having to complete a system (i.e., tracker) re-initialization that can often accompany a loss of signal, and hence degrade system performance. A resulting output that can be generated by combining measurements from the two systems, can be less susceptible to signal degradation in either system.

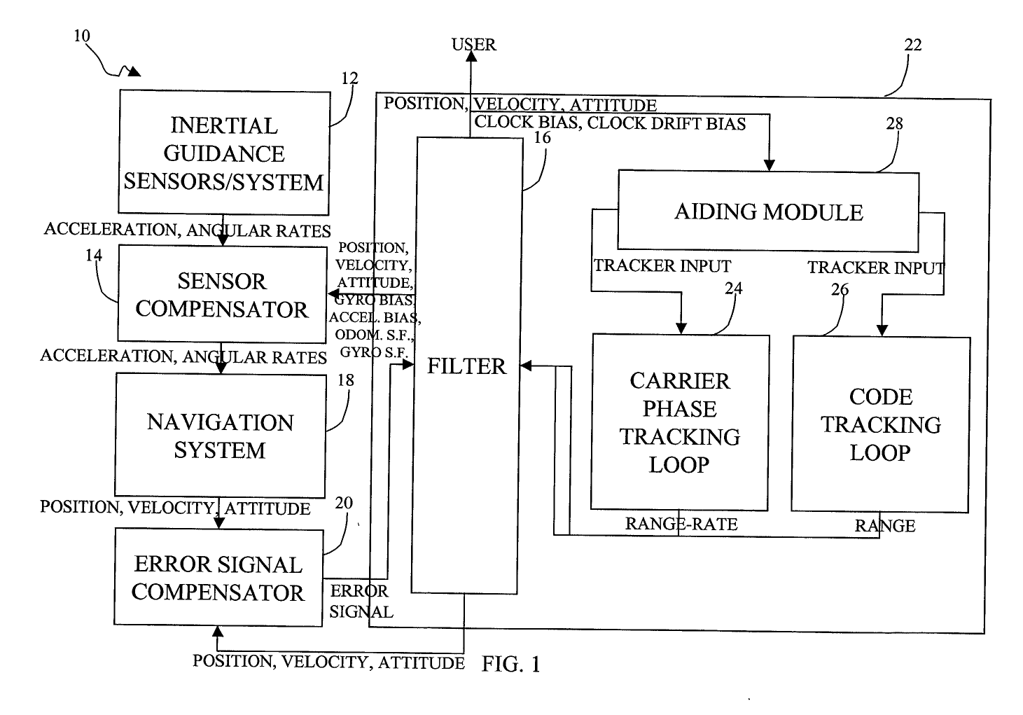

Referring now to FIG. 1, there is a system 10 illustrating one embodiment of the disclosed methods and systems. For the illustrated system, an inertial guidance system (IGS) 12 that can include inertial sensors as previously provided herein with respect to FIG. 3, including but not limited to at least one gyroscope, at least one odometer, and at least one accelerometer, can provide inertial measurements, although such inertial sensors are provided merely as illustrations and are not intended for limitation. The inertial sensor system 12 can include one or more processors that can be related to one or more of the inertial sensors, where the processors can have instructions for filtering or otherwise processing the data from the respective sensors. In some embodiments, the processing can be implemented using hardware that can be analog or digital, or a combination thereof, and can also include microcode or other software processing.

In the illustrated systems, the inertial sensor system 12, otherwise referred to herein as an inertial guidance system (IGS), can be understood herein to include the inertial sensors and sensor interfaces and processing (e.g., filtering, amplification, A/D, etc.), and can provide inertial data measurements to a sensor compensator 14. In one embodiment, for example, the IGS 12 can provide to the compensator 14 measurements that can include acceleration and/or angular rates, although those with ordinary skill in the art will recognize that such measurements are merely illustrative, and other or fewer measurements can be provided without departing from the scope of the methods and systems disclosed herein. Accordingly, the compensator 14 can adjust the measurements using scale factors, biases, etc., as provided by an input from a filter 16 as will be discussed further herein. The compensated measurements can thereafter be provided to a navigation system 18 that can translate the received measurement data into, for example, estimates of parameters including position, velocity, and attitude, although other parameter estimates can be computed or otherwise determined based on the embodiment, the inertial parameters, etc.

The navigation system 18 can thereafter provide the estimated parameters to an error signal compensator 20 that can compare the estimated parameters from the navigation system 18, with estimated parameters from the filter 16. As will be provided herein, the filter 16 can provide parameter estimations based on a GPS system or receiver 22. The error signal compensator 20 can accordingly compare the GPS estimated parameters from the filter 16 and the estimated parameters from the navigation system 18, to provide difference data that can determine whether the navigation system sensors, and or components of the GPS system 22, may require adjustment in terms of compensation, tracker alignment, etc. In the illustrated embodiment, the difference or error data from the error compensator 20 can be used by the filter 16 to estimate parameters. Some of the parameters can be position, velocity, attitude, etc., that can be used by other systems, while other of the estimated parameters can provide compensation to the IGS 12 and GPS 22 systems, respectively, including for example, estimates of GPS clock bias, GPS clock drift bias, gyroscope and odometer scale factor, accelerometer bias, and gyroscope bias, although such examples are provided for illustration and not limitation.

Those of ordinary skill in the art will recognize that the illustrated GPS receiver/system 22 of FIG. 1 includes only a portion of such a receiver as is well known in the art, and includes therein a carrier phase tracking loop 24 and a code tracking loop 26 as is known to those of ordinary skill in the art. As is also known in the art, the carrier tracking loop 24 can provide a range-rate measurement by tracking the doppler characteristics of the GPS signal, while the code tracking loop 26 can provide a range measurement by tracking the pseudo-random noise code provided by a GPS satellite. Those of ordinary skill in the art will recognize that the illustrated carrier phase tracking loop 24 and code tracking loop 26 can have different embodiments, and the methods and systems herein are not limited by the design of the respective trackers 24, 26. Additionally, those of ordinary skill in the art will appreciate that the illustrated receiver 22 can receive GPS signals from one or more GPS satellites, and accordingly, the illustrated receiver 22 can include one or more carrier phase trackers 24, code trackers 26, and/or filters 16.

The illustrated GPS receiver 22 does not include such features as an antenna interface, receiver, Radio Frequency (RF) to Intermediate Frequency (IF) down-converter, analog-to-digital converter, clock, satellite pattern table, etc., as is known to those of ordinary skill in the art. The FIG. 1 receiver 22 is thus depicted to illustrate the disclosed methods and systems, and is not intended to be a comprehensive illustration of a GPS receiver 22.

As FIG. 1 illustrates, a range-rate measurement from the carrier phase tracker 24, and a range measurement from the code tracker 26, can be provided to the filter 16. The filter 16 can use the tracker outputs to generate parameter estimates in accordance with the signal measurements parameter estimates from the IGS 10 and navigation system 18. For example, from the GPS measurements, in one embodiment, the filter 16 can provide estimates for range, range-rate, position, velocity, attitude, acceleration, GPS clock bias, and GPS clock bias drift, although such parameters are provided for illustration based on one embodiment, and are not intended for limitation. In one embodiment, the filter 16 can be a Kalman filter, although the methods and systems are not limited to such an implementation, and other predictive and/or adaptive techniques can be used without departing from the scope of the disclosed methods and systems. Accordingly, the filter estimates can be provided to the compensator 20 that can compare the GPS and IGS parameter estimates to generate the error signal or residual. The error signal can be returned to the filter 16, and the filter 16 can provide an estimate of the parameters based on the error signal.

Additionally, the filter 16 can provide parameter estimate data to the sensor comparator 14 to allow a determination or computation of compensation factors (e.g., bias, scaling) to be applied to the IGS sensor data based on the GPS signal.

Accordingly, because the illustrated filter 16 is adaptive and predictive and receives an error signal from the error signal compensator 14, the filter 16 can be configured to weight the IGS or GPS signal data based on the error signal data and the respective signal quality from the IGS and GPS systems 10, 22. Accordingly, although not indicated in FIG. 1, the filter 16 can receive measurement data from the IGS 12 and/or the GPS system 22 that can include the sensor data, for example, from the inertial sensors, and such measurements and/or data can be used to compute parameter estimates including parameters that can compensate the IGS and GPS systems. Alternately, the filter 16 can receive the position, velocity, and attitude as computed from the inertial sensor data and provided by the navigation system 18.

The respective outputs from the filter 16 to the sensor comparator 14 and trackers 24, 26 can therefore be weighted based on the error signal and the quality of signal from the IGS and GPS systems 12, 22. Accordingly, if the received GPS signal quality is not high (e.g., low signal-to-noise ratio (SNR), etc.), the IGS estimates may be provided greater weight by the filter 16, and alternately, the generally more accurate GPS estimates can be provided greater weight when the GPS signal is available. The filter 16 in the illustrated embodiment, is thus an adaptable filter, and can be configured to include a time constant as is well-known in the art. In the illustrated system, the filter 16 time constant can be selected to match an anticipated average period of GPS signal degradation or signal loss.

The illustrated filter 16 can also provide compensation in the form of parameter estimates to an aiding module 28 that can transform the parameter estimates to a coordinate system compatible for the respective trackers 24, 26. (Additionally, although not shown in FIG. 1, the sensor compensator 14 can include an aiding module to convert the parameter estimate data from the filter 16 to a coordinate system that is compatible with the IGS system 12 outputs.) For example, as provided herein, parameters to be estimated can include position, velocity, and attitude, and a range estimate can be provided to the code tracker 26 from a position estimate that can be converted to a range via the aiding module 28, while a range-rate can be provided to the carrier phase tracker 24 via a filter velocity estimate that can be converted by the aiding module 28.

As also indicated in FIG. 1, the position, velocity, attitude, and other parameter data, can be provided to a user, where the user can be a system, display, application, etc., including, for example, an automobile location or positional display system. Furthermore, those with ordinary skill in the art will recognize that although the illustrated system provides the filter output data to the trackers 24, 26, the filter output or compensation data can be provided to other GPS receiver components. Those with ordinary skill in the art will also recognize that in some embodiments, the filter 16 can provide updates or compensation data to the IGS and/or GPS systems 12, 22 at one rate or time interval, while the IGS 12 sensors and GPS 22 receiver can be providing and/or processing data (e.g., trackers updated) at a different rate or time interval than the filter 16 updates.

In an embodiment, the filter 16 may be considered to have two components that can operate at two different rates, where a first component can process data from the trackers 22, 24 and other GPS system 22 components at one rate, while another component can process data from the error signal compensator 20 as provided herein. In such an embodiment, the illustrated filter 16 can be depicted as having two separate filter features. Similarly, the IGS system 12 components can be processed by a filter that is not shown in the FIG. 1 system, and such filtered IGS signals can be provided to the error signal compensator 20.

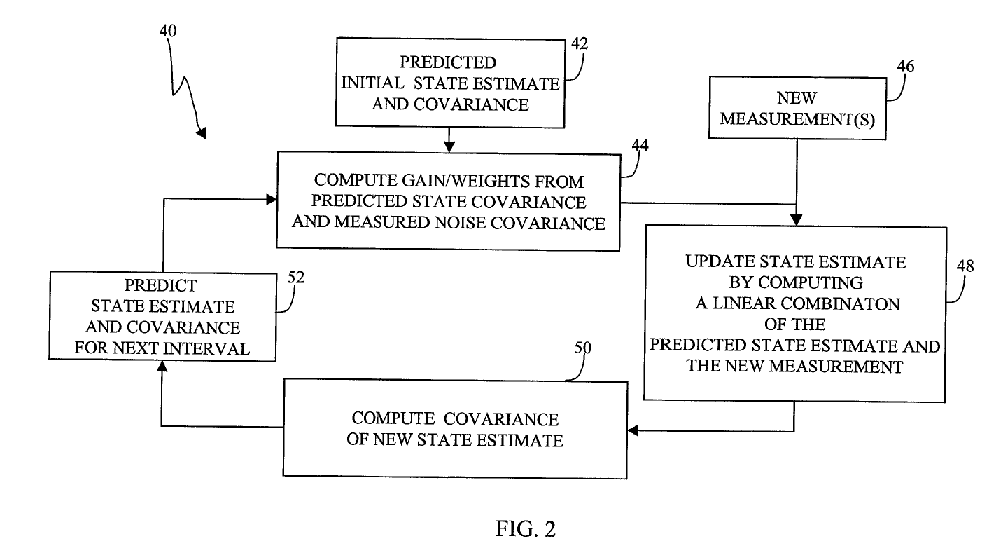

Referring now to FIG. 2, there is a block diagram of a Kalman filter 40 that can be one embodiment filter 16 according to the disclosed methods and systems. Although FIG. 2 provides a generic description of a Kalman filter, the FIG. 2 illustration can be described with respect to the illustrated methods and systems of FIG. 1. For a Kalman filter, a parameter or set of parameters that can be referred to as a state vector, can be estimated based on an adaptive and predictive scheme and for a linear system such as that of FIG. 1. A Kalman filter is thus a technique for estimating the states of the system given observations of the system (e.g., IGS, GPS measurements) that can be modeled as having additive “white” or Gaussian noise. The Kalman filter can generate an optimal solution by minimizing a state error correlation matrix by using a recursive algorithm in which a non-linear difference equation represents the covariance matrix of the optimal estimate error. This equation can be solved recursively or iteratively.

Accordingly, as indicated in FIG. 2, an initial predicted state estimate and variance for the parameters can be provided 42, where the state variances for the multiple parameters can be represented in a covariance matrix that includes variances (along diagonal) and covariances. As discussed herein, the covariance matrix for the FIG. 1 system can include uncertainty values for the GPS measurements, the various IGS sensor measurements, initial process noise, measurement noise (e.g., biases on a gyroscope due to a temperature that can be unknown, etc.). From the covariance matrix and initial predicted state estimate, a set of weights can be computed 44. As provided herein, the weights can be used, together with measurements from the sensors or systems 46, to provide an updated state estimate by computing a linear combination of a predicted state estimate and the new measurement, where for the illustrated system, the new measurement can include the measurements from the IGS and GPS systems. The weights or gain can be used to determine the influence of the new measurements on the estimation.

Once the updated state estimate is obtained 48, a covariance of the state estimate can be computed 50, and a new prediction for the next interval can be computed 52. From the predicted covariance, new weights or gains can be computed 44, and the recursive process of FIG. 2 can be repeated for subsequent measurement intervals.

As indicated previously, the characteristics of the filter 16 can include a time constant based on an expected time interval of GPS signal degradation or loss. For example, based on the embodiment, estimates for multipath effects, jamming, and signal interference can be provided and incorporated into the filter 16.

Those of ordinary skill in the art will recognize that the GPS signal quality data can be determined by signal processing components that can filter, amplify, demodulate, and provide a signal-to-noise (SNR) estimate or other indicia of SNR, for the respective GPS satellite signals. In one embodiment, the respective GPS SNR or other signal quality data can also be input to the filter 16. Furthermore, SNR data from one or more of the inertial sensors in the IGS 12 can be provided to the filter 16.

In one embodiment of the FIG. 1 filter 16 where the FIG. 1 filter is a Kalman filter and the IGS includes three gyroscopes, three accelerometers, and one odometer, the filter 16 can have on the order of sixteen states, where the states can include three position states, three attitude states, three accelerometer bias states, three to six gyroscope bias states, three gyroscope scalefactor states, one odometer scalefactor state, a (GPS) clock bias state, and a (GPS) clock bias drift state. Other states could include velocity, range, range-rate, acceleration, angular rates, etc. Those with ordinary skill in the art will recognize that the states of the Kalman filter 16 can vary according to application.

The FIG. 1 system can be implemented on a single hardware component using a single processor with instructions for providing the various features or modules of the FIG. 1 components, including the IGS 12, GPS 22, and filter 16. Accordingly, in one embodiment, the features of FIG. 1 can be understood to be software modules that can be executed by a single processor. As indicated previously, the FIG. 1 modules can be combined or otherwise rearranged, etc. In an embodiment, multiple processors on a single or multiple hardware boards or platforms can be used.

What has thus been described is a method and system for integrating a IGS system and a GPS receiver. A predictive filter can measure signal quality from the GPS receiver and accordingly provide parameter estimates by appropriately weighting signal data from the GPS receiver and the IGS system. When GPS signal quality is high, the GPS signal data can be provided proportionately greater weight than the IGS system data, and the IGS/GPS integrated filter outputs can provide compensation to the IGS system for bias errors, etc. Alternately, if the GPS signal data is degraded or unavailable, the IGS signal data can be provided proportionately greater weight than the GPS signal data to provide higher quality inputs to the GPS receiver trackers than would otherwise be available.

The methods and systems described herein are not limited to a particular hardware or software configuration, and may find applicability in many computing or processing environments. The methods and systems can be implemented in hardware or software, or a combination of hardware and software. The methods and systems can be implemented in one or more computer programs executing on one or more programmable computers that include a processor, a storage medium readable by the processor (including volatile and non-volatile memory and/or storage elements), one or more input devices, and one or more output devices.

The computer program(s) is preferably implemented using one or more high level procedural or object-oriented programming languages to communicate with a computer system; however, the program(s) can be implemented in assembly or machine language, if desired. The language can be compiled or interpreted.

The computer program(s) can be preferably stored on a storage medium or device (e.g., CD-ROM, hard disk, or magnetic disk) readable by a general or special purpose programmable computer for configuring and operating the computer when the storage medium or device is read by the computer to perform the procedures described herein. The system can also be considered to be implemented as a computer-readable storage medium, configured with a computer program, where the storage medium so configured causes a computer to operate in a specific and predefined manner.

Although the methods and systems have been described relative to a specific embodiment thereof, they are not so limited. Obviously many modifications and variations may become apparent in light of the above teachings. For example, although the illustrated method and system include a filter that can be a Kalman filter, other predictive filters can be used. Although the illustrated system indicates filter outputs being received by one aiding module, the various filter outputs can be provided to dedicated aiding modules for the various outputs. Similarly, the error signal provided by the error signal compensator can have multiple components. Although the illustrated system indicated a filter output that includes position, velocity, and attitude, such outputs are provide for illustration, and in an embodiment, the filter 16 can have many states (i.e., can estimate many parameters), and hence the outputs to the user, the GPS trackers, and the IGS system can vary from each other, and can vary from the outputs illustrated in FIG. 1. For example, the IGS system can receive filter outputs relating to acceleration and/or angular rates, while the GPS receiver can receive range and/or range-rate estimates for input to the trackers 24, 26.

Many additional changes in the details, materials, and arrangement of parts, herein described and illustrated, can be made by those skilled in the art. Accordingly, it will be understood that the following claims are not to be limited to the embodiments disclosed herein, can include practices otherwise than specifically described, and are to be interpreted as broadly as allowed under the law.

What is claimed is:

1. A method for integrating a global positioning system receiver and an inertial guidance system, the method comprising,
providing a first estimate for at least one parameter, the first estimate provided by the global positioning system,
providing a second estimate for the at least one parameter, the second estimate provided by the inertial guidance system,
providing a difference between the at least one first estimate and the at least one second estimate,
providing an estimate of the at least one parameter based on the difference data, and,
compensating at least one of the inertial guidance system and the global positioning system using the estimate.

2. A method according to claim 1, wherein providing an estimate includes combining the first estimate and the second estimate.

3. A method according to claim 1, wherein providing an estimate includes weighting the first estimate and the second estimate.

4. A method according to claim 1, wherein providing an estimate includes weighting the difference.

5. A method according to claim 1, wherein providing a first estimate includes providing a first estimate of at least one of a position, a velocity, an attitude, an acceleration, and an angular rate.

6. A method according to claim 1, wherein providing a second estimate includes providing a second estimate of at least one of a position, a velocity, an attitude, an acceleration, and an angular rate.

7. A method according to claim 1, wherein providing a difference includes providing an error signal.

8. A method according to claim 1, wherein providing a difference includes providing a difference at an interval that is different than the interval for which the first estimate and the second estimate are provided.

9. A method according to claim 1, further including,
receiving at least one GPS signal, and,
demodulating the at least one GPS signal.

10. A method according to claim 1, wherein compensating includes providing at least one of a range, a range-rate, a position, a velocity, an attitude, an acceleration, an angular rate, a gyroscope bias, an accelerometer bias, a gyroscope scale factor, and an odometer scale factor to compensate the inertial guidance system.

11. A method according to claim 1, wherein compensating includes providing at least one of a range, a range-rate, a position, a velocity, an attitude, an acceleration, and an angular rate to at least one of a carrier phase tracking loop and a code tracking loop.

12. A method according to claim 1, wherein compensation includes providing at least one of a clock bias and a clock drift bias to the GPS receiver.

13. A method according to claim 1, wherein compensating includes converting at least one of range, range-rate, position, velocity, attitude, acceleration, and angular rate to a coordinate system compatible with at least one of a carrier phase tracking loop and a code tracking loop.

14. A method according to claim 1, wherein the inertial guidance system includes at least one of: at least one accelerometer, at least one gyroscope, and at least one odometer.

15. A method according to claim 1, further including providing the estimate of the at least one parameter to at least one of a user, a display, an application, or a system.

16. A method according to claim 1, wherein providing an estimate includes providing a Kalman filter.

17. A method according to claim 16, wherein the Kalman filter includes a position state, an attitude state, an accelerometer bias state, a gyroscope bias state, a gyroscope scalefactor state, an odometer scalefactor state, a clock bias state, and a clock bias drift state.

18. A method according to claim 16, wherein the Kalman filter includes a time constant based on at least one of an expected loss of signal and an expected signal degradation time interval for a GPS signal.

19. A method for integrating a global positioning receiver system (GPS) and an inertial guidance system (IGS), the method comprising,
providing a Kalman filter,
providing measurement data from the GPS and the IGS to the Kalman filter, and,
compensating the GPS and the IGS based on at least one state of the Kalman filter.

20. A method according to claim 19, wherein providing a Kalman filter includes providing a Kalman filter having states that include a position state, an attitude state, an accelerometer bias state, a gyroscope bias state, a gyroscope scalefactor state, an odometer scalefactor state, a clock bias state, and a clock bias drift state.

21. A method according to claim 19, wherein providing measurement data includes providing at least one of range and range-rate data based on the GPS.

22. A method according to claim 19, wherein providing measurement data includes providing at least one of acceleration and at least one angular rate based on the IGS.

23. A method according to claim 19, wherein compensating includes providing at least one of a position, velocity, and range-rate for input to a carrier phase tracking loop.

24. A method according to claim 19, wherein compensating includes providing at least one of a position, velocity, and range for input to a code tracking loop.

25. A method according to claim 19, wherein the IGS includes at least one accelerometer, at least one gyroscope, and at least one odometer.

26. A method for integrating a global positioning receiver system (GPS) and an inertial guidance system (IGS), the method comprising,
providing at least one parameter estimate based on the GPS,
providing at least one parameter estimate based on the IGS,
based on the parameter estimate from the GPS and the parameter estimate from the IGS, generating at least one combined parameter estimate for at least one of a position, an attitude, an accelerometer bias, a gyroscope bias, a gyroscope scalefactor, an odometer scalefactor, a clock bias, and a clock bias drift, and,
compensating the GPS and the IGS based on at least one combined parameter estimate.

27. A method according to claim 26, further comprising providing a Kalman filter to generate the at least one combined parameter estimates.

28. A method according to claim 26, wherein the Kalman filter includes a time constant based on at least one of an expected loss of signal and an expected signal degradation time interval for a GPS signal.

29. A method according to claim 26, wherein providing at least one parameter estimate based on the GPS includes providing at least one of a position, velocity, and attitude measurement.

30. A method according to claim 26, wherein providing at least one parameter estimate based on the IGS includes providing at least one of a position, velocity, and attitude measurement.

31. A system for integrating a global positioning receiver system (GPS) and an inertial guidance system (IGS), the system comprising,
a filter, and,
at least one processor for implementing the filter, wherein the processor includes instructions to:
receive data from the GPS and the INS,
compute at least one of a position, an attitude, an accelerometer bias, a gyroscope bias, a gyroscope scalefactor, an odometer scalefactor, a clock bias, and a clock bias drift, and,
provide at least one of the estimated position, attitude, accelerometer bias, gyroscope bias, gyroscope scalefactor, odometer scalefactor, clock bias, and clock bias drift to the IGS and GPS system.
